(19) United States
(12) Patent Application Publication
(10) Pub. No.: US 2005/0084832 A1
(43) Pub. Date: Apr. 21, 2005

(54) Stereotypy test apparatus and methods

(76) Inventors: Paul Adriaan Jan Janssen, Vosselaar (BE); Paulus Joannes Lewi, Turnhout (BE); Roger Francois Leonarda Rosiers, Vosselaar (BE)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 10/499,385

(22) PCT Filed: Dec. 19, 2002
(86) PCT No.: PCT/EP02/13094

(30) Foreign Application Priority Data
Dec. 21, 2001 (EP) 01870293.6

(51) Int. Cl. G09B 19/00

(52) U.S. Cl. 434/236

(57) ABSTRACT

A stereotypy test apparatus 10 is disclosed, which is suitable for interactive use in the diagnosis of a psychiatric disorder. The apparatus comprises an input means in the form of a keypad 14 adapted for physical entry of input signals to the apparatus 10 and a control means 28 which is adapted to prompt a candidate to enter during a test session a succession of said input signals. The control means 28 analyses entered said input signals in order to derive and output from said analysis one or more output signals indicative of at least one value RC, RS which is used in the diagnosis of the presence or absence in said candidate of at least one predetermined psychiatric disorder or of the candidate's predisposition theretowards. The input signals comprise a succession of choices (1-9) selected freely by said candidate from a plurality of mutually independent choices (1-9) and a said output signal RC, RS is indicative of repetitive patterns among said candidate choices.

### FIELD OF THE INVENTION

This invention relates to apparatus and methods for the use of diagnostic tools, and in particular to a stereotypy test apparatus suitable for interactive use in the diagnosis of a psychiatric disorder, such as an emotional, mental, cognitive or personality disorder and/or for early detection of a predisposition theretowards. The present invention also relates to a method of using such apparatus for diagnosis or early detection of such disorders. The present invention also relates to a diagnostic network using results gained from the apparatus.

### BACKGROUND TO THE INVENTION

It is known to provide apparatus for the detection of certain mental disorders and prior art examples of such proposals for equipment and associated methods are disclosed in for example WO 95/29447, U.S. Pat. No. 6,186,154B1, U.S. Pat. No. 4,730,253 and U.S. Pat. No. 4,028,819. These apparatus propose arrangements for assessing certain disorders using interactive aids but by no means cover all possible mental disorders and it is still desirable to seek apparatus and methods which can improve on current proposals and preferably also determine the presence, absence or a predisposition towards disorders not yet dealt with adequately.

One aspect of the diagnosis of mental disorders is that medical practitioners should be able to compare diagnoses and thus be able to use data and results from other groups. To achieve this, it is necessary to have a diagnostic tool which provides repeatable values and results independent of the place, time or environment of the investigation or of the health care person carrying out the test. At the same time some variability in the test procedure is desirable so that learned behaviour can be compensated for. Ideally, this variability should be within well-defined limits and should not cause distortions in the diagnoses based on the test method.

In Biological Psychiatry, vol. 46, No. 5, pages 662-670 (1999), Progress in Neuro-psychopharmacology & Biological Psychiatry, Vol. 18, No. 7, 1169-1185 (1994) and Biological Psychiatry, Vol. 49, No. 1, pages 71-77 (2001), the authors describe an interference test designed to study attention deficit and lack of concentration in schizophrenic patients. The patients performed a LEFT or RIGHT key press that was accompanied by a stimulus, which occurred randomly on the left or right side of the computer screen.

In WO 01/87142, published on Nov. 22, 2001, a method of acquiring information about the attentional state of a subject is described. The method involves (a) presenting to the subject a sequence of a predetermined number of stimuli over a predetermined period of time, wherein the sequence includes target and nontarget stimuli, (b) scoring the response of the subject on the percentage of the targets responded to and the percentage of nontargets responded to, and (c) on the basis of the scoring of step (b), making a determination of the attentional state of the subject.

U.S. Pat. No. 5,913,310 discloses a method and associated apparatus for monitoring, diagnosis and treatment of psychological and/or emotional conditions in human patients with the aid of a micro-processor-based video game. This again encompasses a test that seeks to measure and evaluate attention deficit.

There still is a need for simple neurocognitive tests that are able to measure several parameters at the same time, which can be correlated with mental conditions, such as lack of internal inhibition and attention deficit.

### SUMMARY OF THE INVENTION

It is an object of the present invention to provide improved apparatus and methods for the use of diagnostic tools, and in particular to provide an improved stereotypy test apparatus suitable for interactive use in the diagnosis of a psychiatric disorder, such as an emotional, mental, cognitive or personality disorder and/or for early detection of a predisposition theretowards. It is a further object of the present invention to provide a method of using such an improved tool in that diagnosis or early detection. Another object of the present invention is to provide a diagnostic network using the results gained from the apparatus. It is a particular object of the present invention to provide an improved apparatus and method for use in the diagnosis of schizophrenia.

Accordingly, the present invention provides stereotypy test apparatus suitable for interactive use in the diagnosis of a psychiatric disorder, the apparatus comprising an input means adapted for entry of physical input signals to the apparatus and a control means which is adapted to prompt a candidate to enter during a test session a succession of said input signals and to analyse entered said input signals in order to derive and output from said analysis one or more output signals indicative of at least one value which is used in the diagnosis of the presence or absence in said candidate of at least one predetermined psychiatric disorder or of the candidate's predisposition theretowards, said input signals comprising a succession of choices selected freely by said candidate from a plurality of mutually independent choices and a said output signal being indicative of repetitive patterns among said candidate choices. The psychiatric disorder may comprise an emotional, mental personality or cognitive disorder, and may in particular comprise a disorder which falls within the general description of a lack of internal inhibition, such as for example schizophrenia and which can be distinguished from attention deficit and lack of concentration.

Said control means may include a record means which is adapted to make a record of the frequency during a said session with which at least one said choice or a group thereof is made, said control means being adapted to base said analysis at least in part on said record.

Said record means may comprise a series of storage elements each of which is representative of a said choice or group of choices, wherein a said storage element is incremented each time an associated said choice or group of choices is made.

Said record means may be adapted to record the selection of each possible variation of pairing said choices, a said record comprising for example dyadic frequencies between successive said choices.

A said output signal may be based at least in part on repetition or randomness within a said session of at least one sequence of candidate choices or groups of choices.

Said apparatus may further comprise means for selectively limiting the total number of choices available to, or made by, a said candidate.

Said control means may be adapted to prompt said candidate to input a said choice periodically under the control of a timer associated with said control means, said period preferably being settable and comprising for example one second between successive prompts and a said prompt comprising for example an audible signal.

Said apparatus may keep a record of the number of times no entry is made during the time period between successive said prompts, said record comprising a missed-prompt total which is preferably settable to a maximum and a derivation of the total number of entries made preferably taking account of said missed-prompt total.

Said apparatus may keep a record of the number of times multiple entries are made during the time period between successive said prompts, said multiple-entry total preferably having no limit and a derivation of the total number of entries made preferably taking account of said multiple-entry total.

Said apparatus may keep a record of the total number of prompts given, a derivation of the total number of entries made preferably taking account of said prompt total.

Said apparatus may further comprise means for selectively setting the maximum number of prompts in a session, an exemplary said maximum number comprising two hundred.

The response time taken by said candidate to make said choices may be measured and said analysis may be adjusted in reflection of said response time, a said output signal optionally including an indication of said response time.

Said input means may comprise a tactile input means, such as for example one, more or a combination of a set of buttons, a keyboard or pad, a touch screen and a voice controlled input, said input means also preferably comprising a display means for user display of instructions, feedback or results.

Said choices may be represented on said input means in a format which is substantially the same for each said choice.

Said apparatus may be used for the early detection of at least one of a lack of internal inhibition and potential psychosis in particular in young persons, such as for example in persons under the age of sixteen years;

The present invention also provides a method of using an interactive diagnostic tool in a diagnostic method for assessing during a test session the presence or absence of a predetermined psychiatric disorder in a candidate or of the predisposition of said candidate towards said disorder, the method including:
a) offering said candidate a free choice among a predetermined number of user inputs;
b) prompting said candidate to input freely a succession of physical input signals reflecting mutually independent choices from amongst said number, said prompting comprising for example a periodic audio or visual prompt; and
c) analysing said user inputs and determining a value for use in the diagnosis of said presence, absence or predisposition to a said disorder in dependence on the randomness of the choices made by said candidate.
   The method may include determining said randomness in dependence on repetitive patterns among said candidate choices.

Said psychiatric disorder may comprise a lack of internal inhibition, attention deficit, psychosis and in particular schizophrenia and a presence in, or a tendency theretowards, of said candidate may be determined in the event of a substantially non-random succession or of repetitive sequences in said candidate choices in a said session.

### BRIEF DESCRIPTION OF THE DRAWINGS

The present invention will now be described by way of example only and with reference to the accompanying drawings, in which:

FIG. 1 is a representation of an apparatus according to an embodiment of the present invention;

FIG. 2 is a functional block diagram of the apparatus of FIG. 1;

FIGS. 3a to 3d are schematic diagrams of storage elements in the form of a series of registers of FIG. 2;

FIG. 4 is a flow chart giving an overview of a test session employing the apparatus of FIGS. 1 to 3d;

FIG. 5 is a flow chart giving an overview of the entry and processing/analysis of input signals in a session according to FIG. 4;

FIG. 6 is a flowchart showing a variation of the flowcharts of FIGS. 4 and 5;

FIGS. 7a to 7d show results of different groups of patients compared to a control group, displayed in the form of an accumulative frequency distribution;

FIG. 8 is a representation of a computer-based apparatus according to an embodiment of the present invention;

FIG. 9 is a representation of a further computer based apparatus according to an embodiment of the present invention; and

FIG. 10 is a network for providing a health care person with access to a database of results in accordance with an embodiment of the present invention.

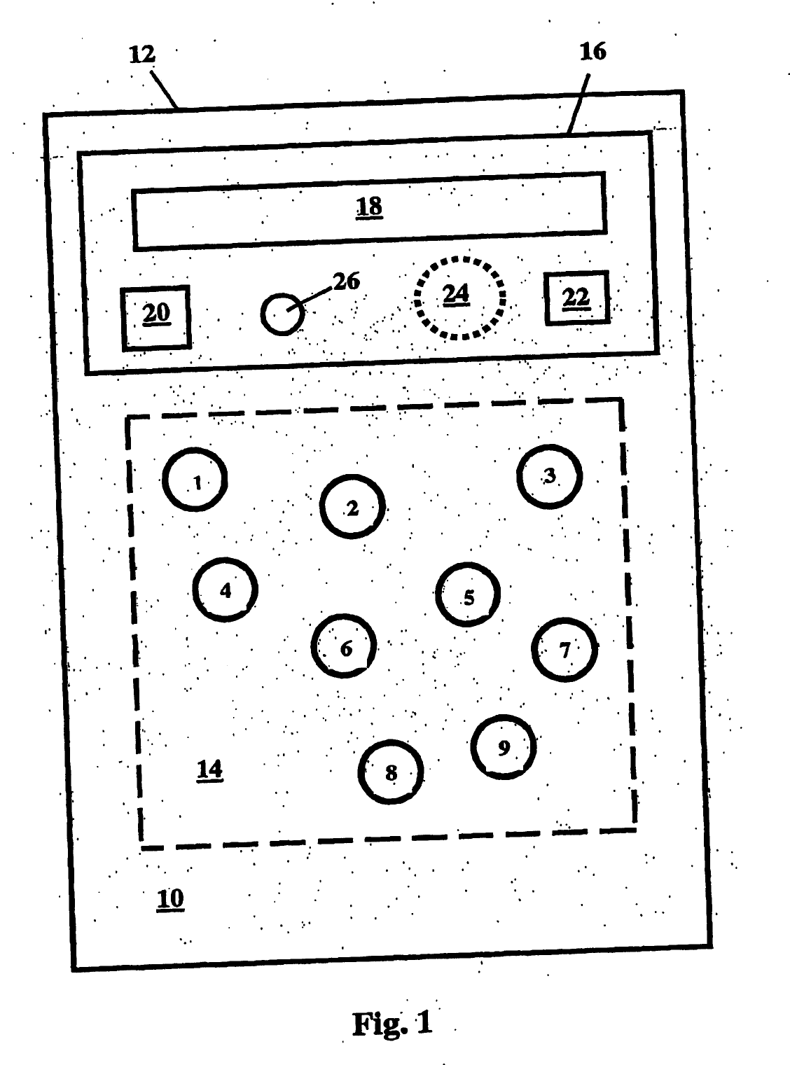

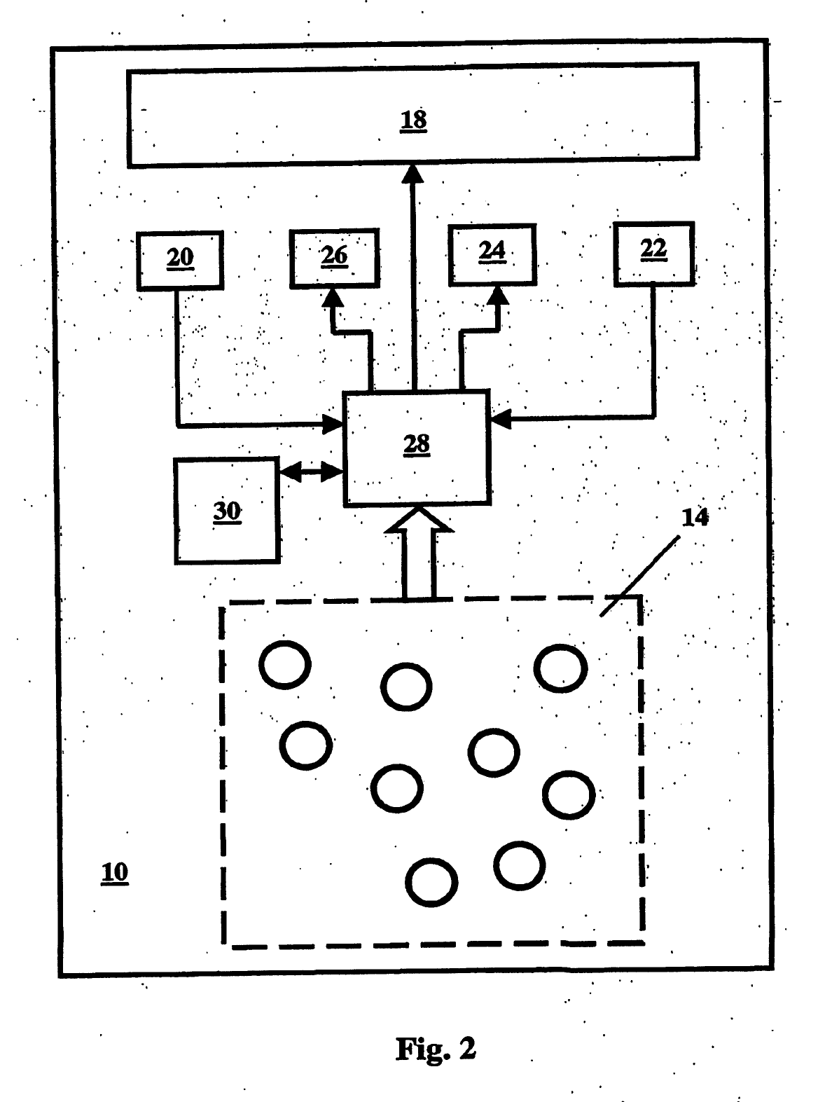

### DETAILED DESCRIPTION OF PREFERRED EMBODIMENTS

The present invention will be described with reference to certain embodiments and with reference to the above mentioned drawings, but such description is by way of example only and the invention is not limited thereto but only by the appended claims. The apparatus and methods disclosed are suitable for use in the diagnosis of psychiatric disorders and in particular of those which fall within the type sometimes referred to as a lack of internal inhibition. These disorders are believed to be caused by the sufferer being held captive to their own thinking and may manifest themselves by a lack of inhibition in the inner self which prevents proper control of repetitive patterns. Indeed stereotyped behaviour, or contextually inappropriate and unintentional repetition of a response or behavioural unit, has long been recognized as a characteristic feature of schizophrenia. Early signs may be exhibited in young people by one or more of, and sometimes a combination and/or succession of, learning difficulties, petty crime and drug abuse. One particular example dealt with in the exemplary embodiments is the presence or absence of, or predisposition towards, schizophrenia, although it will be appreciated that the present invention is not limited to only this disorder and may also find advantageous use with respect to further disorders such as for example manic depression, cognitive disorders and other conditions known to the skilled person to be susceptible to analogous diagnosis. The present invention is enabling the quatification of stereotyped behaviour using—in a preferred embodiment—a computerized apparatus.

Surprisingly, it was found that the present apparatus could be used to measure a parameter (i.e Redundancy of Content, RC) that can be correlated with internal inhibition together with another parameter (Multiple Entries) that can be correlated with attentional deficit and lack of concentration.

Referring to the drawings, an interactive stereotypy test apparatus 10 comprises a casing 12 which includes an input means 14 of which a keypad is only one example, a command and control portion 16, which includes an output means 18, e.g. display means such as a liquid crystal display or similar. The output means 18 can be any suitable device which provides any form of understandable output, such as a printer; a connection to a visual display unit; a digital memory means such as a computer memory or a replaceable storage device such as a diskette; or a connection to a telecommunications network, e.g. the Internet or a Local Area Network via a modem and/or a LAN interface, e.g. Ethernet interface.

The input means 14 comprises a series of user inputs in the form of a finite number of means for physically entering a signal, each means for entering a signal being associated with one of a series of sensibly different intellectually understandable symbols such as numbers, shapes, letters, colours. For example, nine buttons 1-9 may be laid out on a keypad 14 in accordance with a specific pattern, e.g. a pattern as proposed by Axmacher et al. in the article “Informationsstatistische Untersuchungen zur Struktur einfacher Handlungsfolgen bei endogenen Psychosen”, Arzneimittel-Forschung, 20, No. 7, 1970. In order to make sure that the sensory impression provided by the input means 14 is constant for all patients in all locations it is preferred if the same pattern is used for all such tests. Further, it is preferred if the sensory impression of the input means 14 is neutral, that is there should be no regular structure or representation derivable from the input means which may be used as an aid to determining a random sequence. For example, the buttons (1-9) on the keypad 14 may be all substantially identical in shape and appearance and are externally unmarked, i.e. their numerical designations 1-9 are hidden from a user and are reserved for internal use only as will be described in greater detail below. The arrangement of the buttons should be such as not to suggest a regular array, e.g. in columns and rows or straight diagonals of equal length. Patients with mental disorders may show high intelligence and may have exceptional ability in some aspects of mathematics. Hence, a regular array may be used with certain mathematical rules in order to simulate the spontaneous generation of a random sequence despite the fact that this sequence has been generated by a person suffering from mental or personality disorders using an algorithm. The command and control portion 16 includes a test start button 20 and a test stop button 22, along with one or more warning/indicator devices, e.g. a speaker a 24 and/or a light 26 such as a light emitting diode (LED) 26.

The test apparatus 10 includes a control means in the form of a processing engine 28 which is adapted to: receive signals from each of the buttons 1-9 on the keypad 14; to receive inputs from the start and stop buttons 20, 22; to provide instructions, test results and/or user feedback via the display 18; to provide user instructions and/or feedback via the speaker 24; to indicate test resetting via the LED 26 and to communicate with a series of registers N, P, Q, X. The processing engine 28 may be a micro-processing engine or a programmable digital element such as a Gate Array, a PAL, PLA, or FPGA.

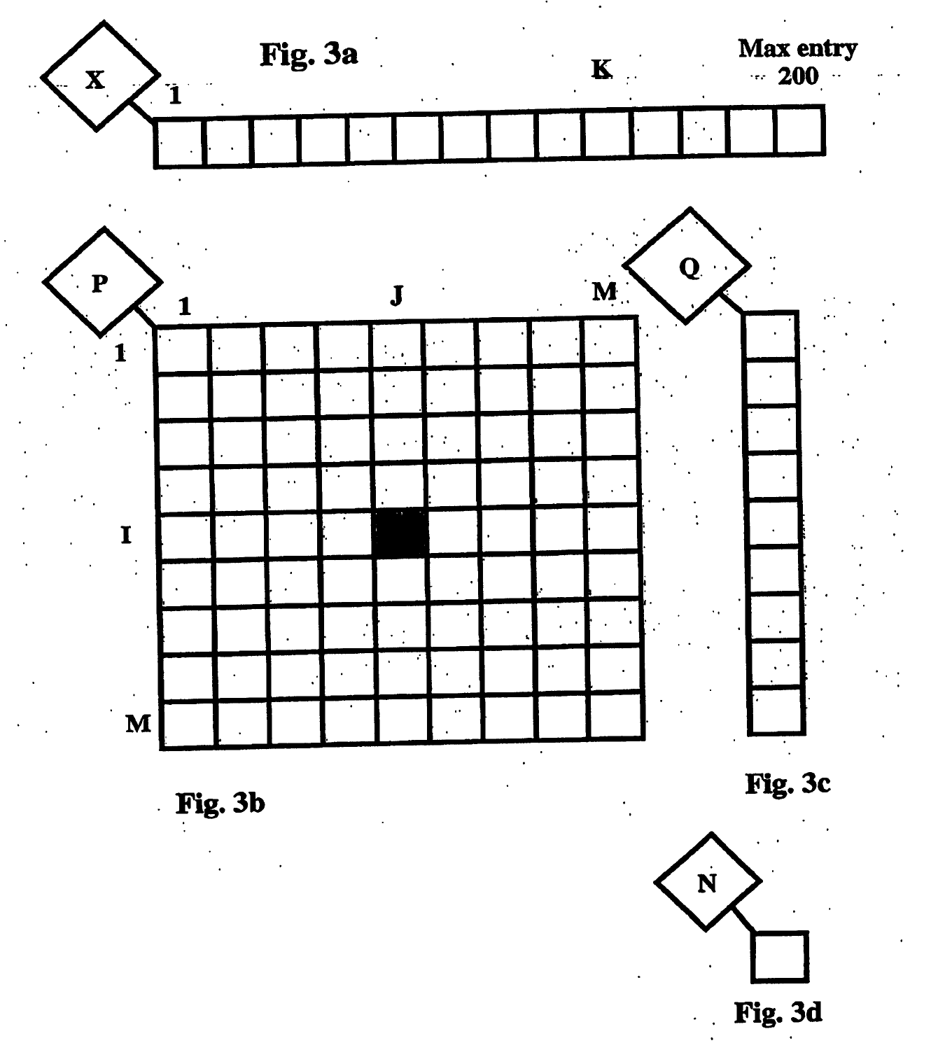

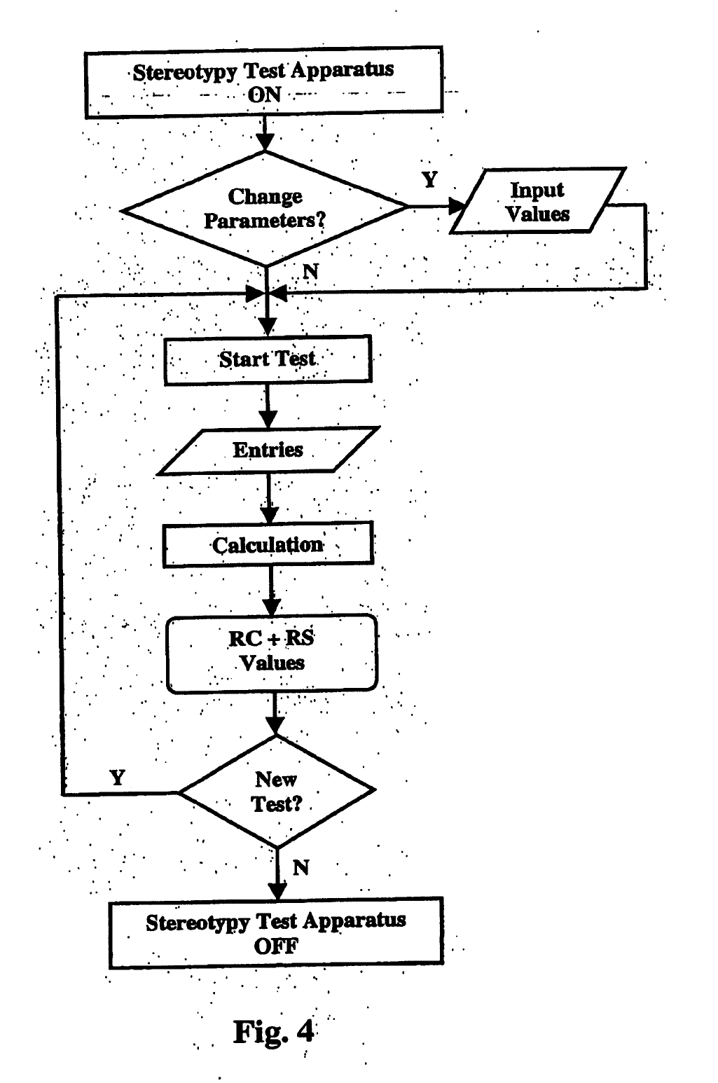

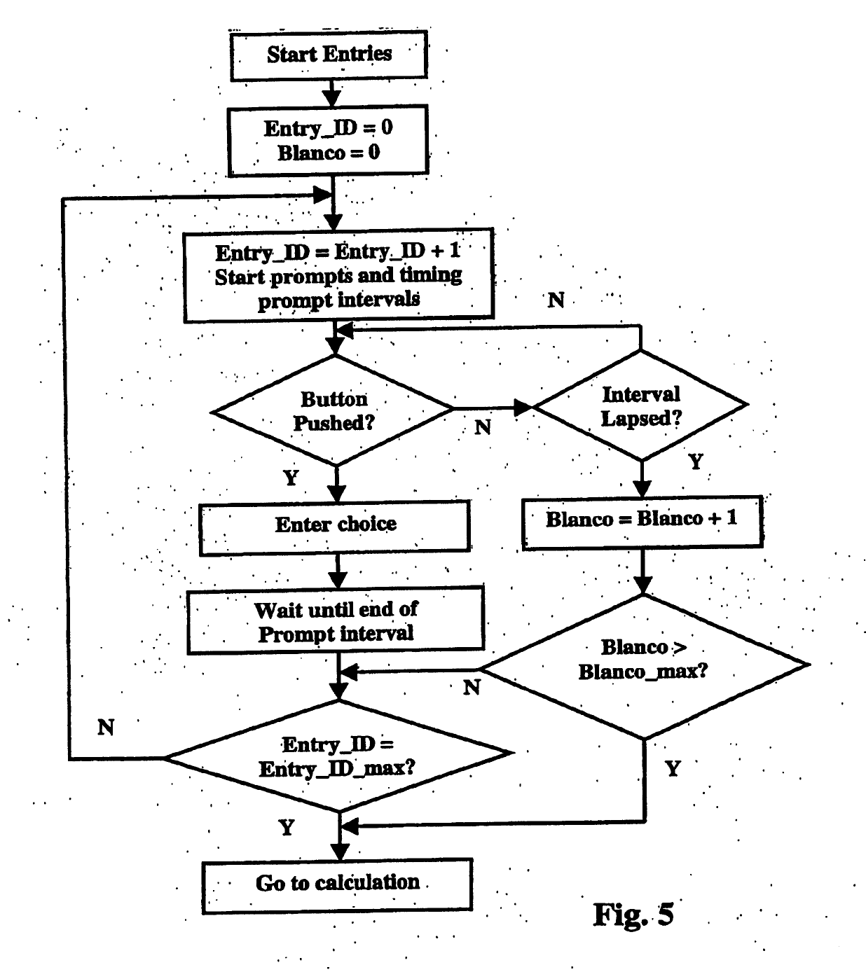

Storage devices are provided in the form of the registers N, P, Q, X as represented in FIGS. 3a, 3b, 3c and 3d and are adapted to hold a record of the input signals which are made using the keypad 14. The apparatus is preferably provided with a LAN interface and/or a modem connection for connection to a LAN or to a Wide Area network such as the Internet.

During a test session, a candidate is prompted to make a succession of choices among the buttons 1-9 and to press any one of them each time they receive a prompt. The choice is entirely free, the buttons 1-9 being mutually independent in both selection between buttons and in successive selections, except that the patient is instructed to try and obtain a random sequence without pressing any of the buttons twice in a row.

Pressing whichever button 1-9 is chosen indicates the candidate's choice for that particular prompt and the number of the button chosen is sent to the processing engine 28 in the form of an input signal. It should be remembered here that all the buttons look the same to a candidate and he is not provided with any indication of what happens internally to the apparatus on pressing any particular button or sequence. This may be found to help in preventing the memorisation of keyboard pattern. All that the candidate is required to do is to try and press a button each time they hear a prompt signal and to try and to choose between buttons on successive prompts in a random manner without selecting the same choice twice in a row. In an alternative embodiment, feedback of button pressing may be provided, e.g. an indication of which button has been pressed may be displayed on the LCD 18.

The mode of prompt given by way of example in this embodiment is a settable test parameter and comprises a sound signal which is transmitted by the processing engine 28 using the speaker 24. The timing of prompts is settable, for example by an administrator, and an exemplary prompt interval is 1 second.

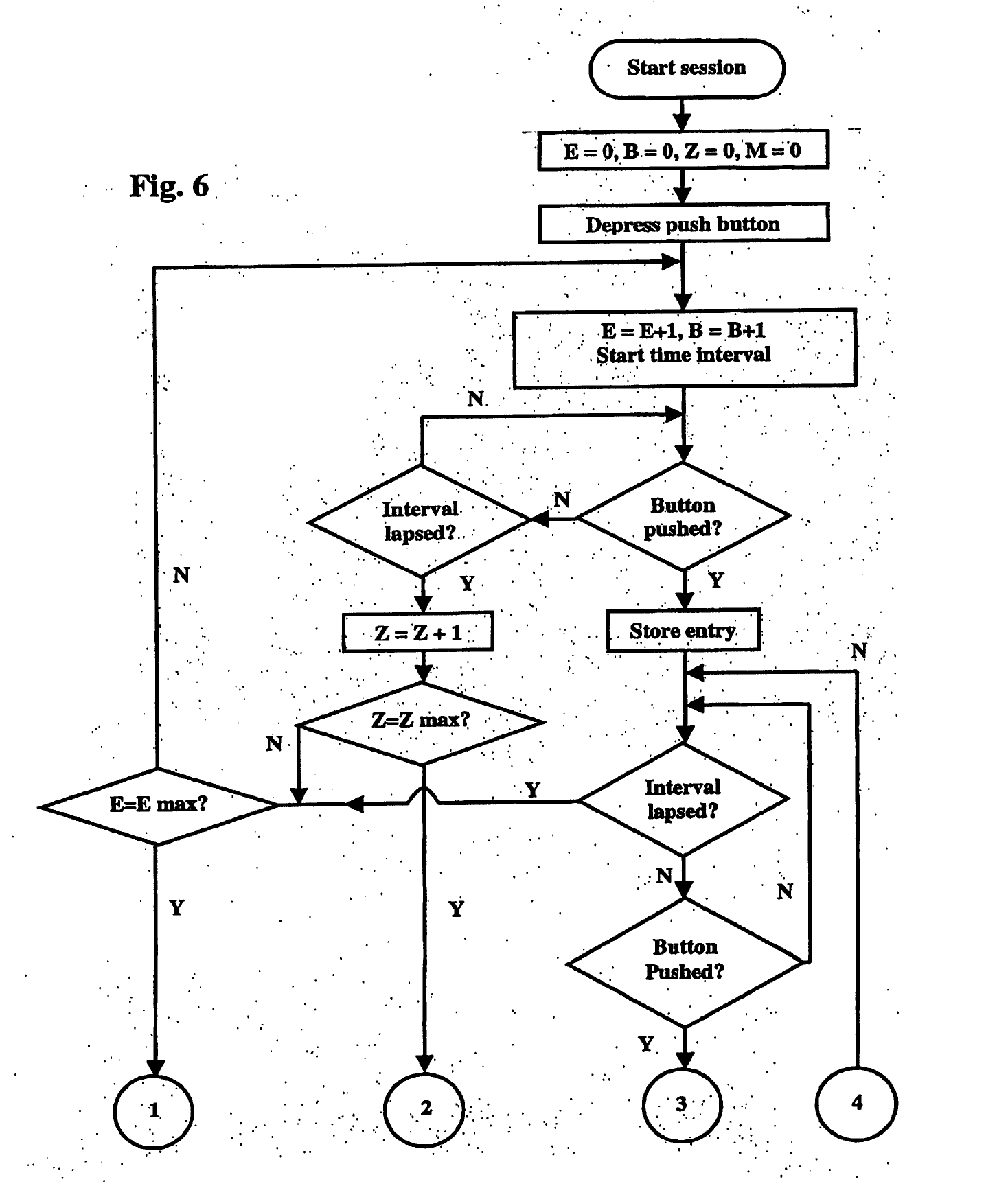

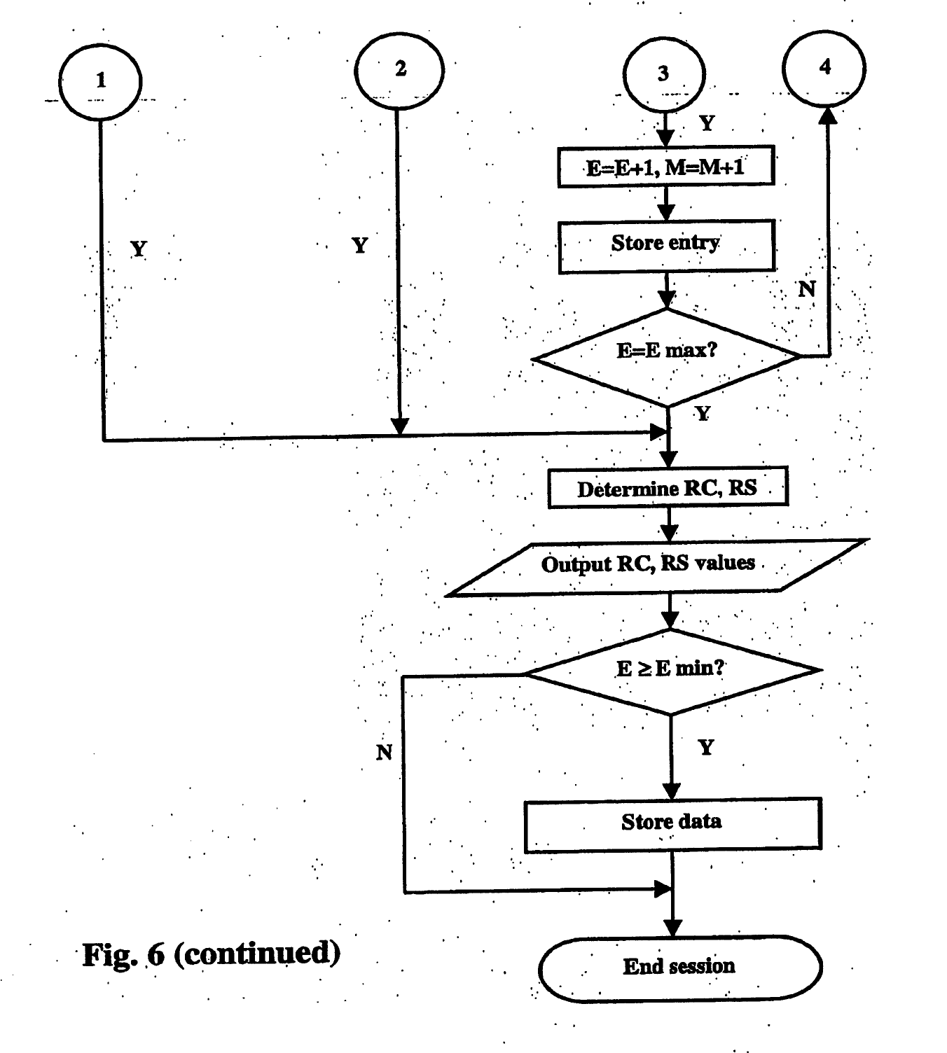

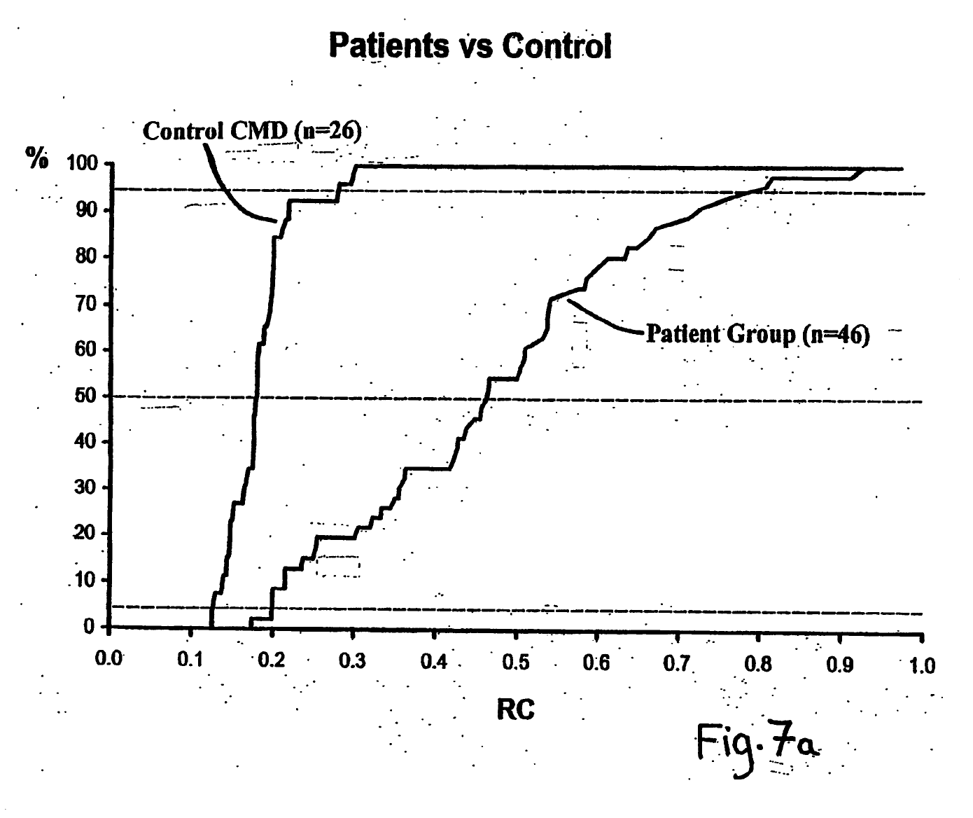

The prompt interval is settable such that there is sufficient time between choices for them to be independent but not long enough for much thought by the candidate between successive prompts, such that each said choice is preferably a substantially instantaneous reaction or snap-choice in response to a prompt. It is not necessary to use the prompts as a strict guide to choice entry and the prompts may be used merely to set up a rhythm for the candidate to follow, as will be explained in greater detail below with respect to the variation considered in association with FIG. 6. It will also be appreciated that the mode of prompt may be varied in other embodiments, such as by the substitution of a visual prompt if a particular candidate is deaf. In addition, other handicaps or preferences can be taken account of without departing from the scope of the invention, using for example an input means in the form of a touch-screen or voice activated apparatus.

The key features are that the choices made must be mutually independent and, within the limitations of each candidate, the choices should be made rapidly without any great thought by the candidate between choices. For the sake of consistency between results of different candidates, the choices would preferably be made substantially instantaneously in response to successive prompts. For certain disabilities, the input means 14 may be modified such that a record may even be made by a neutral observer who merely records an association made between the candidate with a particular choice amongst a group of choices howsoever presented.

The response-time taken by a candidate to make his choice and to enter it can be derived from the time between the prompt and an input signal. This response-time may be recorded and the analysis may be adjusted in reflection of the response time. In this manner, account can be taken of candidates whose mental processes adapt to the speed of the prompts and it may be found useful to indicate response times in an output signal and possibly also to adapt the prompt timing to take account of such situations.

During a test session, a candidate is required to make their choices amongst the buttons 1-9 in a controlled manner in response to a rhythm set up by the prompts. Missed prompts may take place and, within limits, may not invalidate a session but should be recorded. The manner in which this is taken care of in the diagnosis is discussed below but, as far as the candidate is concerned, no action is required in the event of a missed prompt or late response other than simply progressing to the next choice on the next prompt. In order to obtain a useable sample, a succession of a certain number of choices must be made. 200 prompts may for example be set as a default value, although the figure may be varied by adjusting a parameter setting of the apparatus.

The number of prompts which can be missed, or otherwise not validly responded to, before the processing engine 28 determines that no acceptable diagnosis can be made from a particular session is a third settable test parameter. A default setting of about forty missed or invalid inputs is preferred, before considering that a diagnosis resulting from an affected test session has become unreliable. The three test parameters of prompt period, number of prompts given and number of prompts missed can be altered, preferably under the control of the supplier of the apparatus 10 or at least an administrator, e.g. on initialisation of the test apparatus 10.

Once the apparatus 10 has been powered-up and any changes to the test parameters set, the candidate is placed in a preferably controlled environment (i.e. few distractions) with the test apparatus 10 and a test session is initialised using the “start” button 20. Initialisation of a test session can be performed either by the candidate themselves or under the supervision of an administrator.

A first register X is referred to as the vector of consecutive entries and is a count of the total number of valid entries made, X(K) containing a number between 1 and the maximum number set for prompts (e.g. default 200). On initialisation, this register is set to zero (Entry_ID=0) and can have a maximum value no greater than the maximum number of prompts set for the session (maxentry=200). Substantially at the same time, the register (“Blanco”) for missed or invalid entries is also set to zero (Blanco=0).

When a prompt is made, the prompt count is incremented (Entry_ID=Entry_ID+1) and a timer measures the interval which has elapsed since the prompt was made. If no valid input signal was received by the end of the one-second prompt period, it is deemed for the purpose of the test session that no choice was made in time and the missed prompt register is incremented (Blanco=Blanco+1). If the maximum number of missed entries has been reached, (e.g. Blanco=40), the processing engine 28 moves directly into the calculation used to derive the test results for that particular test session, assuming that a minimum number of entries have been made, e.g. 50. If the minimum number of valid choices have not been entered, the test session is terminated and the result is declared invalid and not recorded. If the maximum number of prompts set has not yet been reached, the next prompt follows after a predetermined interval, e.g. 1000 mS.

If the maximum number of prompts have been given, the processing engine 28 progresses to the calculation used to derive output signals RC, RS useful in determining the presence, absence or a predisposition towards a psychiatric disorder, e.g. schizophrenia. Consideration will now be given to the data structure employed in the calculation used for determining the output signal from the results of a test session.

As discussed above, the first register X stores the total number of choices validly entered and this is referred to for convenience as the vector of consecutive entries (maximum 200 for the default setting). A second register P stores in tabular form the number of times a particular sequence of buttons 1-9 were chosen in succession, M representing the total number of choices made available to a candidate during the particular session in question and set by way of example in default to nine choices. The table P covers each possible pairing of keys for successive operation (i.e. Dyadic or two-by-two relationships) and, in the particular example shown, the shaded co-ordinate X(I,J) would store the number of times one of the nine buttons designated as “I” was chosen following the prompt immediately following one in which a button designated as “J” had been chosen, all in the same session. This table of stored values and its contents are referred to for convenience as the Dyadic frequencies.

A further register Q contains the frequency with which a particular button has been depressed, such that Q(I) represents the frequency with which button I has been chosen and is the sum of all the frequencies/entries in row I of the table stored in register P. Another register N records the total number of valid entries made.

Once the data for a session has been gathered, the processing engine 28 performs a calculation to determine combined values which may be used to determine if a patient has, or has a likely predisposition to, the mental or personality disorder, e.g. schizophrenia. The output is in the form of content redundancy RC and symbol redundancy RS and is indicative of the randomness of the candidate choices in a particular test session. The calculation of the content and symbol redundancies RC, RS for each sequence of results (i.e. candidate choices) from a test session is performed in accordance with the equations outlined below.

Start of Calculation:

M: Number of symbols (e.g. M=9)

P: Table of M×M Dyadic Frequencies

P(I,J) indicates the frequency with which symbol I precedes symbol J in the given sequence of choices.
N: Number of Entries

$$N = {\sum }_{I = 1}^{M} {\sum }_{J = 1}^{M} P ( I , J )$$

If N=0 set HD=HS=RC=RS=0, go to end of calculation.
HD: Dyad Entropy

$$HD = ( - \frac{1}{N} {\sum }_{I = 1}^{M} {\sum }_{J = 1}^{M} P ( I , J ) {log}_{2} P ( I , J ) ) + {log}_{2} N$$

HS: Symbol Entropy

$$HS = ( - \frac{1}{N} {\sum }_{I = 1}^{M} Q ( I ) {log}_{2} Q ( I ) ) + {log}_{2} N$$

$$with Q ( I ) = {\sum }_{J = 1}^{M} P ( I , J )$$

HM: Maximal Entropy

HM=log₂ M

RC: Context Redundancy
RC=1−((HD−HD)/HM)
RS: Symbol Redundancy
RS=1−(HS/HM)
N.B. it Should be Remembered That:

$$i ) {log}_{2} X = \frac{{log}_{10} X}{{log}_{10} 2} = 3.3219 {log}_{10} X$$

ii) 0 log 0=0 by definition

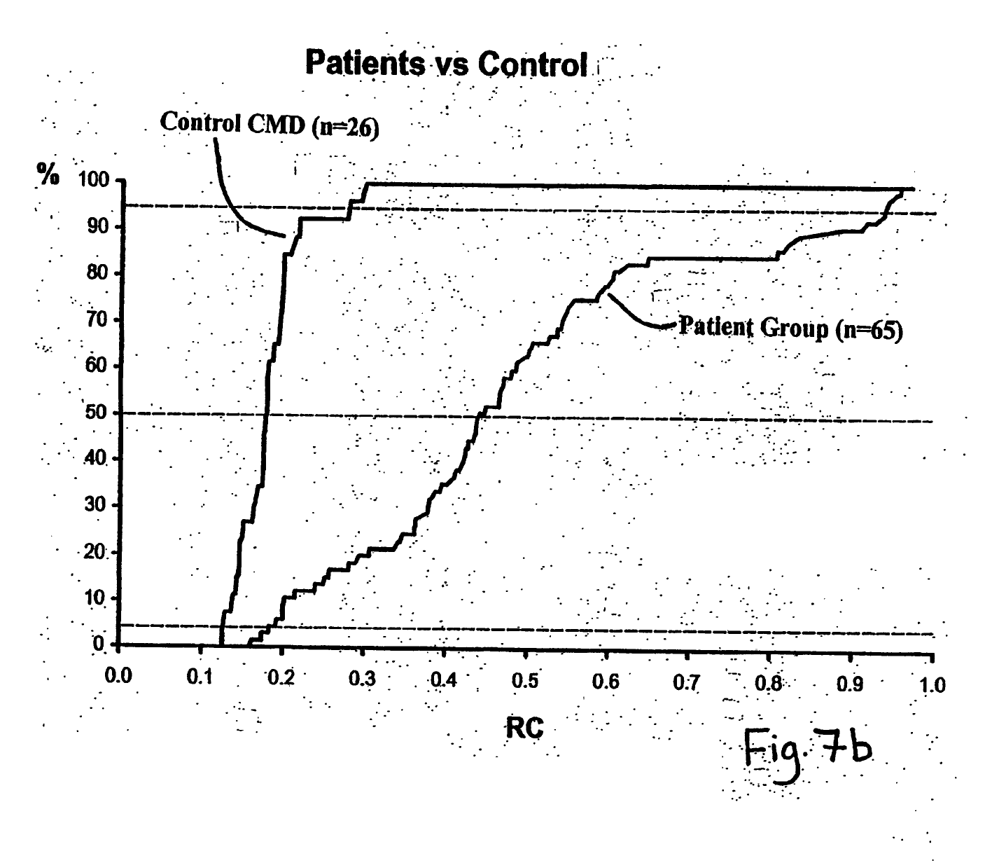

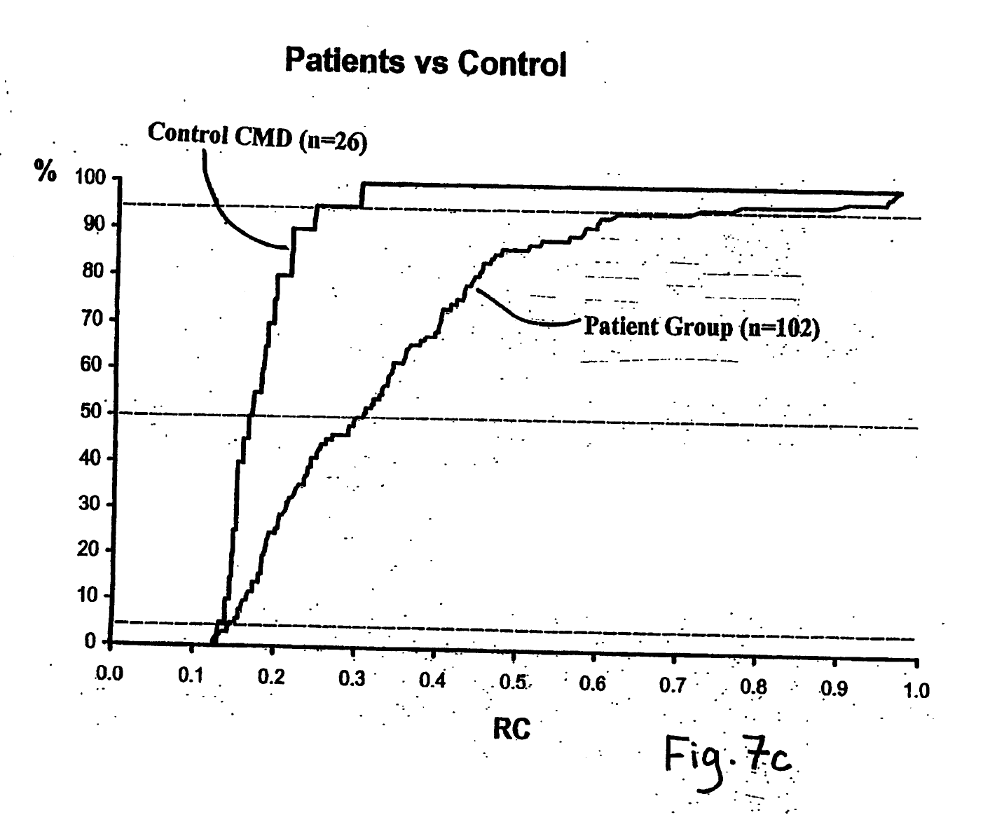

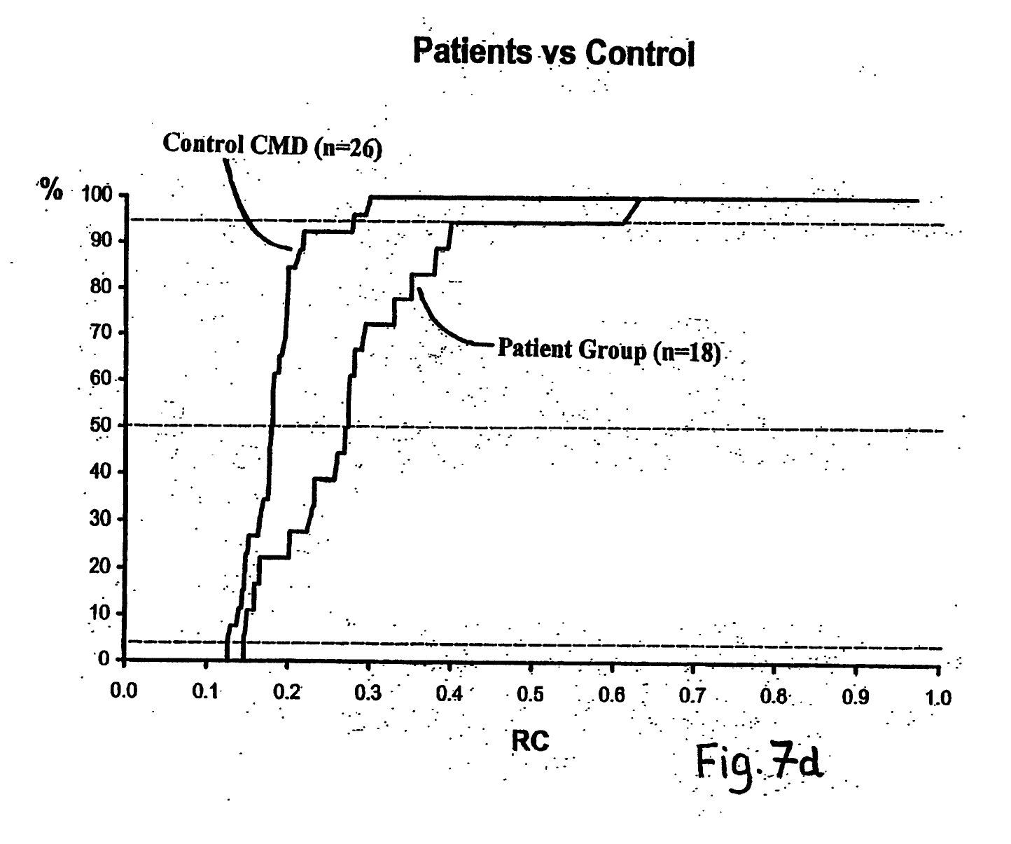

At the end of the calculation, the resulting content and symbol redundancies are used to arrive at a diagnosis, e.g. by comparison with a control group as shown by way of example with particular reference to FIGS. 7a to 7d and described in greater detail below.

A variation of the entry flow will now be considered with particular reference to FIG. 6. In this variation, the prompt signal is used merely to set up a rhythm for the candidate and does not dictate the authenticity of any particular entry which is actually made.

The total number of prompts given is recorded in a prompt register B. If, however, no entry is made between two successive prompts, a missed entry is logged in a missed-entry register Z. If multiple entries are made between any two successive prompts, both entries are accepted as valid choices and added to the total number of entries. The number of such multiple prompts is recorded in a multiple-entry register M. A total-entry register E is used to accumulate the total number of entries made in a test session regardless of how they are made, i.e. single or multiple entries. The total entries made is calculated in accordance with:
E=B+M−Z

At the start of a test session in accordance with the flow chart of FIG. 6, all the registers E, B, Z, M are cleared and set to zero. The test session begins as soon as one of the buttons (1-9) is pressed, although this first key is not recorded as part of the results as the candidate may have had time to think about it. The prompts begin with a time interval between successive prompts, e.g. 1000 mS, and for each prompt the prompt register B is incremented (B=B+1).

Each time a prompt interval expires with no button being depressed, the zero-entry register is incremented (Z=Z+1). If a maximum for zero entries has be reached (Z=Z max), the apparatus goes straight to the calculation for content redundancy RC and symbol redundancy RS. The maximum allowable number of zero entries (Z max) is variable and can be pre-set. An exemplary default setting of 40 may be found a useful starting point for developing the significance of this parameter to any particular group or type of candidates.

On incrementing the zero-entry register (Z=Z+1), a check is made to see if the total number of entries has reached the maximum (E max) set for the test session. The maximum number of entries (E max) is variable can be pre-set. An exemplary default setting of 200 may be found a useful starting point for developing the significance of this parameter to any particular group or type of candidates.

If the total number of zero entries allowable has not been exceeded, the next prompt interval is monitored and any entry or entries made are stored. In each case, it will be remembered that multiple entries in one time interval are all recorded as entries, the multiple entry register M being incremented on each such occasion. At the end of each prompt time interval, whether or not an entry has been made, the total number of entries E is checked against the maximum set (E=E max?).

In the event of successive choices reaching the maximum number set (E max), the apparatus 10 progresses to the calculation of the content and symbol redundancies RC, RS and the values are displayed or otherwise provided for use in later diagnosis. Before the data from any particular test session is stored, a check is made to ensure that the total number of entries made actually meets or exceeds a pre-set minimum (E min), which may for example be set to 50 (E min=50). This ensures that potentially spurious or invalid results are not recorded, such as might be generated for example if the total number of allowable zero entries (Z=Z max) is reached before the minimum number of entries has been recorded (E min). This ends the test session and the results can then be compared with control groups in accordance with FIGS. 7a to 7d.

In each embodiment, the number of missed entries (Blanco; Z) and the number of multiple entries (M) is recorded and may be retrieved for later analysis. It has been found that there is a correlation between these factors and the state of mind of the candidate and they may indicate the need to consider further or filter out at least part of the results. Their values may then be used in more detailed diagnosis or as a basis for further testing. For example, a candidate may be deliberately using the option of missed entries as a way of gaining time to calculate random sequences or to break-up what they might believe to be a repetitive pattern.

Multiple entries, on the other hand, may at least in part represent automatic reactions such as for example drumming the fingers. These may be found to represent just the sort of repetitive patterns being sought or may later be diagnosed as spurious entries. For example, in drumming the fingers, buttons pressed after the initial choice would be restricted by the available order and movement of the digits and may give rise to apparently repetitive patterns which are not actually representative of a real choice. This might indicate the need to filter out the portions caused by the drumming so as to expose the real choices.

FIGS. 7a to 7d are exemplary results of using the present invention on four different groups of candidates who were patients at the time of the tests. Each group of patients was tested by different psychiatric healthcare workers and their results are reproduced graphically in each case in the form of accumulative frequency distributions with a normal set at 50% and control limits at 95% (upper) and 3.5% (lower). In each graph, the patients' results are compared with the results of a control group CMD of 26 candidates (n=26), which are the same set of control results for each comparison.

The results for the control group CMD were obtained by subjecting a sample “n” of 26 randomly selected candidates representative of the population at large. The control group was considered for the purpose of these comparisons not as a definitive example of a “normal” population, but rather represents a group whose overall day-to-day behaviour is not considered by society in general to warrant special treatment and may be referred to for convenience as representative of the so-called “man in the street”.

Referring now in particular to FIGS. 7a and 7b, these results represent the results of two groups of candidates taken from adult patients diagnosed as acutely psychotic, having sample sizes n of 46 and 65 respectively. These patients had not yet been stabilised under care at the time the tests were taken and differences in content redundancy RC are quite acute across the limits of the distribution, i.e. accumulating from about 0.050-0.075 in the region of the lower end, through 0.260-0.275 in the region of the median and 0.500-0.633 in the region of the upper limit.

By way of comparison, FIG. 7c represents the results from a candidate sample size n of 102 taken from candidates who had, by the time of their test sessions, been stabilised by psychiatric treatment. In this case, the content redundancy RC can be seen to be near indistinguishable from the control group CMD in the region of the lower limit, but to have accumulated to a difference of about 0.150 in the region of the median and to be between about 0.300 and 0.350 in the region of the upper limit. While still easily distinguishable from the control sample across most of the distribution, it can be seen that these patients show a marked reduction in content redundancy compared with those yet unstabilised. It can thus be seen that the apparatus of the present invention may help in assessing the effectiveness of stabilising treatments, by providing test results which can be used to compare with unstabilised candidates.

The candidates for the test sessions whose results are presented in FIG. 7d were taken from a sample n of 18 young persons (14 to 16 years old) who were patients placed under observation as a result of behaviour considered to be anti-social and/or potentially psychotic and were not yet stabilised. The content redundancy RC in the region of the lower limits is not much different to that of the control sample, a difference in RC between results of only about 0.020. By the time the median point is considered, however, the difference in RC has accumulated to about 0.100 and in the region of the upper limit the difference has accumulated to anything between 0.120 and 0.300. While the sample size n=18 led to a wide range in difference in content redundancy RC in the region of the upper limit, it can still be seen that there is a detectable difference with the sample group CMD. These results are some way below the differences in RC exhibited by any of the adult populations represented in FIG. 7a to 7c and indicate the particular usefulness of the apparatus of the present invention for detecting disorders at an earlier age. The early indication of discrepancies in content redundancy RC allows early treatment and hopefully also early stabilisation, possibly before the acute stage represented in FIGS. 7a and 7b might be reached.

Although the control group CMD used in the comparison of FIG. 7d was the same as the one used for the comparisons of 7a to 7c, the applicants have obtained very similar comparisons when using a control group of peers, i.e. a control group substantially randomly selected from school children and young persons not under any special observation and care. This demonstrates that the apparatus of the present invention can be used to distinguish between the thought processes of actual or potentially psychotic young persons and the thought processes of their so-called normal peers who exhibit some perhaps similar behaviour but are merely going through the effects of puberty and the associated hormonal, emotional and physical changes associated therewith. The apparatus is therefore particularly useful in the detection of early symptoms of psychosis in young people, e.g. those under the age of about sixteen years.

To make sure that later analysis and comparisons of data can be made, the settable parameters of the test apparatus should be recorded or stored in a non-volatile way, e.g. printed out and/or stored on a non-volatile electronic storage medium. Some examples of parameters which may be stored are:
Number (M) of different symbols used in the test, e.g. 9;
Number of entries before results are calculated, e.g. 200;
Maximum number of warning signals (e.g. 240, may be greater than number of entries due to missed entries);
Set time interval between successive entries, e.g. 1000 ms;
Current trial number;
Content redundancy RC;
Symbol redundancy RC;
Dyad Entropy HD;
Symbol Entropy HS;
Maximal Entropy HM;
The vector of consecutive entries;
Table of frequencies; and
Date and time.

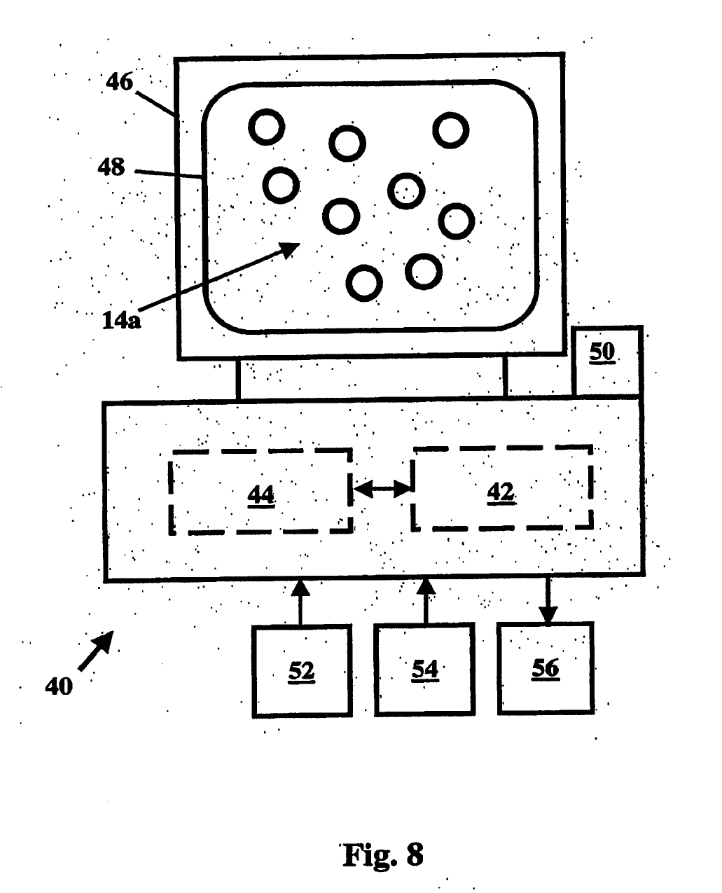

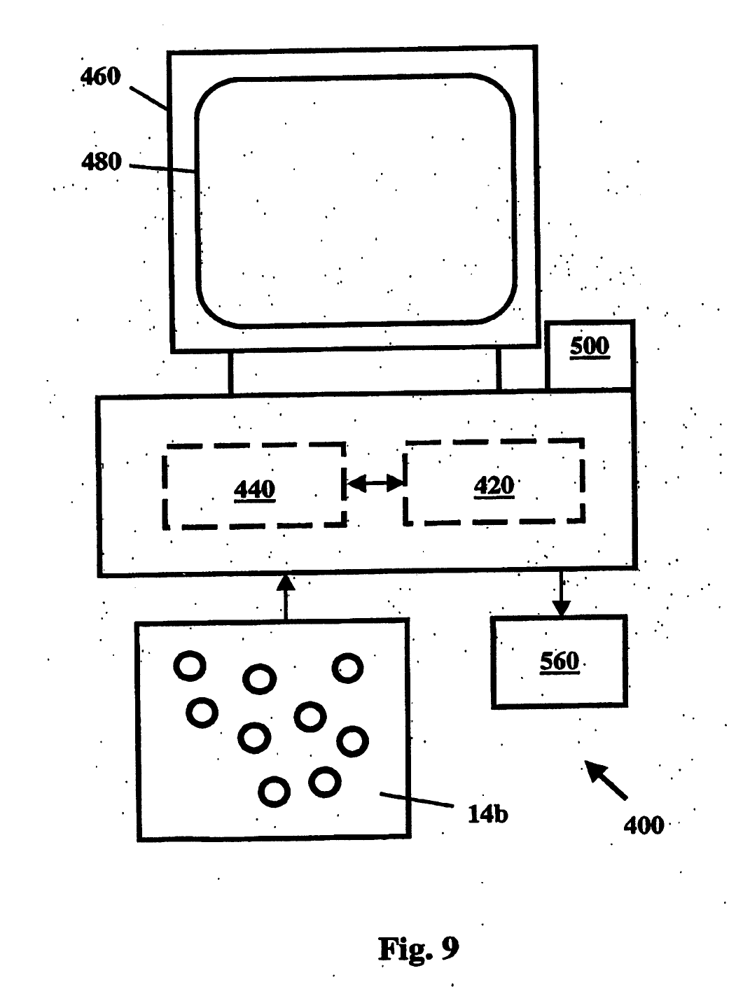

A further embodiment of the present invention will be described with particular reference to FIG. 8 which is based on a general purpose computer 40, e.g. including a memory 42 and a microprocessing engine 44 such as for example one of the “Pentium”™ range as supplied by Intel Corporation, USA. The computer 40 further comprises a visual display unit 46 such as an LCD or CRT provided optionally with touch-screen input means 48 as well as a loudspeaker unit 50 for providing audible warnings and commands. A keyboard 52, mouse 54 and printer 56 may also be provided, which may be useful in configuring the computer 40 for running test sessions but are not normally to be used during a test session. Software is loaded onto the local memory device 42, which may be in the form of a hard disk, a CD-ROM or a diskette, and is used to run the general purpose computer 40. On the visual display unit 46, there is displayed on the touch screen input means 48 an array 14a of choices in the form of a simulated button array 1-9 equivalent to the real button array 14 described above for the first embodiment. By touching a screen representation of a button, a signal representative of a candidate choice is sent to the processing engine 44 indicative of a symbol associated with that button, e.g. a number. The software running on the computer 40 uses these signals as inputs to calculate and record the parameters and test session results RC, RS as described for the first embodiment. In the event of for example physical disability, alternative ways of entering the candidate choice can be used. For example, instead of inputting their choice via a touch screen, a candidate may do so by moving a pointing device such as the mouse 54 to the location of a button on the screen 46 and clicking (or double-clicking) on the mouse 54 to enter the choice. Further alternative input means can be envisaged such as a voice activated input. In this case the computer 40 includes a microphone input and voice recognition software running on the general purpose computer 40. Test set-up and result extraction may be implemented by an administrator using the keyboard 52 and printer 56 as appropriate. The general purpose computer 40 may be provided with a LAN interface card and/or a modem for access to other networks, e.g. for recording or remote diagnosis of the results of test sessions.

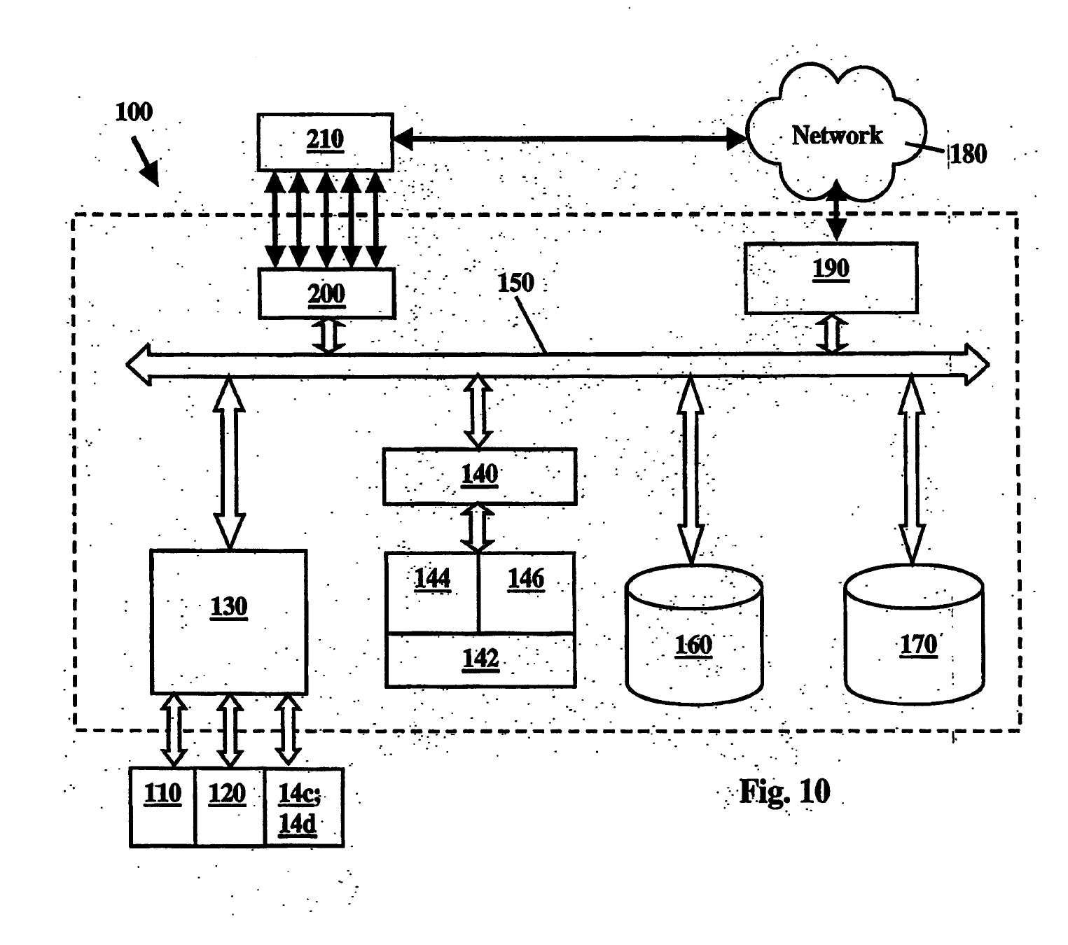

A further embodiment of the present invention will now be described with particular reference to FIG. 9. This embodiment also makes use of a general purpose computer 400, e.g. including a memory 420 and a micro-processing engine 440 such as for example one of the “Pentium”™ range as supplied by Intel Corporation, USA. The computer 400 further comprises a visual display unit 460 having a screen 480 such as an LCD or CRT as well as a loudspeaker unit 500 for providing audible warnings and commands. A keypad 14b is provided, which is substantially identical in layout and operation to the keypad 14 of the first embodiment and its equivalent 14a of the second embodiment. The memory 420 may be in the form of for example a hard disk, a CD-ROM or a diskette, and is used to run the general purpose computer 400. Audible prompts are provided using the speaker 500, although in some cases, such as for example a deaf candidate, visual prompts and/or instructions may be given using the screen 480. In similar fashion to previous embodiments, candidate choices are made using the buttons 1-9 and each time one is used a signal representative of a candidate choice is sent to the processing engine 440 indicative of a symbol associated with that button, e.g. a number. The software running on the computer 400 uses these signals as inputs to calculate and record the parameters and test session results as described for the first embodiment. The printer 560 is used as an output means, from which an administrator or healthcare worker can retrieve a hard copy of the results of tests sessions. In the alternative, the general purpose computer 400 may be provided with a LAN interface card and/or a modem for access to other networks, e.g. for recording or remote diagnosis of the results of test sessions.

In accordance with a further embodiment of the present invention, a general purpose computer 100 is also used in implementing the invention. In addition to possible use by a candidate for taking a test session, a health care worker may share the same computer. The health care worker is provided with access to a database to allow translation of test session results (e.g. RC, RS) into a diagnosis, or for confirmation of a diagnosis already made. Such an arrangement will now be disclosed with particular reference also to FIG. 10.

A programmable computer 100 includes a user interface in the form of one or more peripheral devices for communication with one or more users. A user may be a candidate for a test session, in which case the user interface will preferably include an input means in the form of a keypad 14c in accordance with the keypad 14 of the first embodiment. In addition or in the alternative, such a keypad 14c may be replaced or supplemented by a further and possibly alternative and equivalent means for input of candidate choices, such as for example a mouse 110.

A different user may be a health care worker or test administrator, for whom the input means may comprise alternative or additional and preferably interchangeable peripherals such as a conventional keyboard 14d, although use by a health worker for administrative purposes of the same keypad 14c as the candidate is not precluded, e.g. in between test sessions. It will be noted that such an arrangement allows a candidate and a health care worker to share the same computer 100, simply by connecting their respective peripherals and/or loading their respective configurations.

Associated with the different options of input peripherals 14c, 14d, 110, is a display 120 used selectively to present information, instructions, feedback and results to candidates and administrators/health care workers as appropriate in accordance with predetermined authorisation and access codes. The display 120 may comprise a liquid crystal display (LCD) or a cathode ray tube display (CRT), provided optionally with touch-screen input means as well as a loudspeaker unit for providing audible warnings and commands (not shown separately). On the display 120 there may be displayed the same buttons 1-9 as described above for the first embodiment and in similar fashion to the equivalent option in the second embodiment. By touching an on-screen representation of a button, a signal is sent to the micro-processor 140 indicative of a candidate choice, e.g. a symbol or a number. The software running on the computer 100 uses these signals as input to calculate and record the parameters as described for the first embodiment and then to regress the test result outputs RC, RS onto database information. Instead of inputting candidate-choice signals via a touch screen, this may also be done by moving a pointing device such as the mouse 110 to the location of a button on the screen of the display 120 and clicking (or double-clicking) on the mouse 110 to enter the signal. Further the definition of activating a button may be made by voice and, in that case, the computer 100 would include a microphone input and voice recognition software.

The peripherals 14c, 14d, 110, 120 communicate with the computer 100 through an interface 130 which includes video, serial communication and keyboard adaptation circuitry as appropriate for the or each peripheral connected at any one time. All such circuitry is represented globally by the interface 130 and it will be appreciated that separate input/output ports and interfaces such as video adaptation boards, serial communications and keyboard controllers are employed as appropriate to support the connectivity of the or each particular peripheral 14c, 14d, 110, 120.

The computer 100 is based around a processing engine in the form of a micro-processor 140, such as for example one of the “Pentium”™ range from Intel Corporation. Communication internal to the computer 100 is performed using a data bus 150, which comprises for example an industry standard architecture (ISA) or a peripheral component interconnect (PCI) bus. In addition to the interface circuitry 130 and the micro-processor 140, also connected to the data bus 150 are memory devices, such as a hard drive 160, and (optionally) a CD-ROM and/or DVD drive 170.

The present invention also includes database information, held between the hard drive 160 and the CD/DVD 170, in which records of tests are kept electronically in a retrievable manner. The database should include results not only from patients but also from persons believed to be within known parameters, e.g. the so-called man-in-the-street employed to generate the control group CMD used in the graphs of FIG. 7a to 7d. In this manner, comparisons in accordance with FIGS. 7a to 7d can be made. The database may include bibliographic and other data with respect to a candidate, e.g. age, sex, nationality, educational level, racial type, marital status, address, medication taken at the time of the test, diagnosed disorder (or none), hospitalisation, IQ, language spoken, mathematical ability as well as the relevant test results as indicated above. The database may be associated with a software program which can regress a specific test result onto the entries in the database in order to assist in the diagnosis. It will be noted that it is preferably if the database information on which results are judged is updated periodically or continuously to reflect the increase in available sample size with each candidate who undergoes a test session.

A main memory 142 holds programs executed by the micro-processor 140, which include an operating system and application specific routines. One sub-routine comprises a question and answer programme 144 which is used for gathering patient information, such as personal parameters and results or inputs from one or more test sessions. These personal parameters may be loaded directly, at least in part using the input devices, while further such parameters discussed above such as past performance or medical/social history may be retrieved from database information in one or both of the hard drive 160 and the CD/DVD drive 170. A further subroutine 146 executes a diagnostic programme, which is used to analyse the gathered information to provide indicia used by a health worker to arrive at a conclusion about the presence, absence or predisposition towards the disorder in question, e.g. by regression from the gathered information onto the database information so as to control the quality of the indicia provided to the healthcare worker by taking into account factors which might affect the apparent results RC, RS of any particular test session or series thereof.

The computer 100 communicates with a network 180, such as for example an Ethernet LAN or the internet, through one or more network connection devices. By way of example, two connection devices are shown as alternatives in the form of a network interface card 190 and a modem 200. In the case of the modem 200, the connection to the network 180 is made through a telecommunications network 210. The telecommunications network may comprise a public switched telephone network (PSTN), although in some cases it may be found useful to use a mobile telephone arrangement such as GSM. The connection to remote systems through the network 180 enables collection, diagnosis and reporting of test sessions and associated information gathering or database storage to be performed from remote locations and/or using shared resources between candidates and/or health workers and administrators, e.g. either hardware or software sharing.

Using the above described apparatus a further number of trials were performed as described below

Trial 1.

OBJECTIVE: To evaluate the computerized Stereotypy Test Apparatus (STA), a new neuropsychological test for use in schizophrenia assessment. The task consists in pressing 9 buttons, 200 consecutive times, with one-second intervals as randomly as possible. The computer calculates Redundancy of Context (RC), which measures the lack of randomness in a series of 200 entries, which gives the number of Zero (Z) and Multiple (M) entries within intervals.

METHOD: Thirty severe conduct disordered boys (CD), thirty-three with learning problems (LP) and eighteen matched controls (C) were administered a neuropsychological battery including attention and inhibitory control tests (WAIS codes, d2, Trail-Making, Stroop). Non-parametric statistical analyses were performed.

RESULTS: As in attention and inhibitory control tests, analysis of variance indicated group effect for each STA parameter (RC:p<005; Z:p<012; M:p<001) with the most extreme results in CD and intermediate outcomes in LP. Considering the whole sample, RC was positively correlated with inhibitory deficit (d2F %:p<026) and performance irregularity (d2SB:p<036). M but not Z was strongly and negatively correlated with the attention and inhibitory control performances.

CONCLUSION: STA quickly gives precious neuropsychological data. Mainly, RC and M seem to be partially related to sustained attention and inhibitory control. Their exact specificity and sensitivity need further research.

Trial 2

Thirty young patients seeking treatment for a first-episode of psychotic illness and 25 healthy volunteers participated (Table Trial 2). Five patients were antipsychotic naïve, while the remainder had been medicated with low doses of second generation antipsychotic medications at time of testing.

The Stereotypy Test Apparatus (STA) used in this trial is equipped with nine response buttons are scattered across the face of apparatus. Subjects were instructed to make button press responses, as randomly as possible, paced by a tone signal that occurred 1/sec. Redundancy of context (RC) measured the lack of randomness in the use of the buttons. A battery of neuropsychological tests was used to evaluate cognitive functioning and included measures of memory (verbal and non-verbal), attention, executive and motor function.

Redundancy of context (RC) differed between patient and control subjects (p<.002, see Table 1). Within the patient group, significant correlations were seen between RC and measures of executive function (Verbal Fluency VF; Object Alternation OA) and motor function (Grooved Pegboard dominant hand GP-d; nondominant hand GP-nd).

Correlations between RC and other cognitive variables failed to reach statistical significance.

The results of this study confirm and extend prior findings of a greater degree of stereotyped behaviours in first-episode patients relative to control subjects. Set switching ability and strategy use, two components of the executive system, were moderately strongly related to the degree of stereotypy.

However, the role of impaired fine motor control must be taken into consideration when interpreting these results.

Table Trial 2

| | | Healthy |
|---|---|---|
| | Patients | Volunteers |
| Mean scores: N | 30 | 25 |
| Age | 24.9 (9.0) | 23.2 (3.0) |
| Sex (M/F) | 21/9 | 17/8 |
| Dose of antipsychotic (CPZ) | 268.9 (152.0) | n/a |
| Redundancy of Context (RC) | .40 (.26) | .19 (.13) |
| Correlations: RC and VF | −.42, p < .03 | |
| RC and OA | .37, p < .05 | |
| RC and GP-d | .46, p < .02 | |
| RC and GP-nd | .49, p < 0.1 | |

While the present invention has been particularly shown and described with respect to a preferred embodiment, it will be understood by those skilled in the art that changes in form and detail may be made without departing from the scope and spirit of the invention.

1-18. (canceled)

19. An interactive test apparatus suitable for use in the diagnosis of an emotional, personality or mental disorder, the apparatus comprising an input means adapted for entry of physical input signals to the apparatus and a control means which is adapted to prompt a candidate to enter during a test session a succession of said input signals without producing repetitive patterns in the sequence of input signals and said control means being adapted to process said entered input signals in order to derive and output from said from said processing an output signal indicative of at least one value which is used in the diagnosis of the presence or absence in said candidate of at least one predetermined emotional, personality or mental disorder or of the candidate's predisposition theretowards, said input signals comprising a succession of choices selected freely by said candidate from a plurality of mutually independent choices and a said output signal being indicative of repetitive patterns among said candidate choices.

20. An apparatus according to claim 19, wherein said control means includes a record means which is adapted to make a record of the frequency during a said session with which at least one said choice or a group thereof is made, said control means being adapted to base said analysis at least in part on said record.

21. An apparatus according to claim 20, said record means comprising a series of storage elements each of which is representative of a said choice or group of choices, wherein a said storage element is incremented each time an associated said choice or group of choices is made.

22. An apparatus according to claim 20, wherein said record means is adapted to record the selection of each possible variation of pairing said choices.

23. An apparatus according to claim 19, wherein a said output signal is based on repetition or not within a said session of at least one sequence of candidate choices or groups of choices.

24. An apparatus according to claim 23, further comprising means for selectively limiting the total number of choices available to, or made by, a said candidate.

25. An apparatus according to claim 19, wherein said control means is adapted to prompt to said candidate to input a said choice periodically under the control of a timer associated with said control means, said period preferably being settable and comprising for example one second between successive prompts and a said prompt comprising for example an audible signal.

26. An apparatus according to claim 25, wherein said apparatus keeps a record of the number of times no entry is made during the time period between successive said prompts, said record comprising a missed-prompt total and a derivation of the total number of entries made preferably taking account of said missed-prompt total.

27. An apparatus according to claim 25, wherein said apparatus keeps a record of the number of times multiple entries are made during the time period between successive said prompts, said record comprising a multiple-entry total preferably having no limit and a derivation of the total number of entries made preferably taking account of said multiple-entry total.

28. An apparatus according to claim 25, wherein said apparatus keeps a record of the total number of prompts given, a derivation of the total number of entries made preferably taking account of said prompt total.

29. An apparatus according to claim 25, further comprising means for selectively setting the maximum number of prompts in a session, an exemplary said maximum number comprising two hundred.

30. An apparatus according to claim 19, wherein the response time taken by said candidate to make said choices is measured and said analysis is adjusted in reflection of said response time, a said output signal optionally including an indication of said response time.

31. An apparatus according to claim 19, said input means comprising a tactile input means, such as for example one, more or a combination of a set of buttons, a keyboard or pad, a touch screen and a voice controlled input, said input means also preferably comprising a display means for user display of instructions, feedback or results.

32. An apparatus according to claim 19, wherein said choices are represented on said input means in a format which is substantially the same for each said choice.

33. An apparatus according to claim 19, used for the early detection of at least one of a lack of internal inhibition and potential psychosis in particular in young persons, such as for example in persons under the age of sixteen years.

34. A method of using an interactive diagnostic tool in a diagnostic method for assessing during a test session the presence or absence of a predetermined psychiatric disorder in a candidate or of the predisposition of said candidate towards said disorder, the method including:
a) offering said candidate a free choice among a predetermined number of user inputs;
b) prompting said candidate to physically input freely a succession of input signals reflecting mutually independent choices from amongst said number, said prompting comprising for example a periodic audio or visual prompt; and
c) analysing said user inputs and determining a value for use in the diagnosis of said presence, absence or predisposition to a said disorder in dependence on the randomness of the choices made by said candidate.

35. A method according to claim 34, including determining said randomness in dependence on repetitive patterns among said candidate choices.

36. A method according to claim 34, said psychiatric disorder comprising a lack of internal inhibition, such as a psychosis and in particular schizophrenia, and a presence in, or a tendency theretowards, of said candidate may be determined in the event of a substantially non-random succession or of repetitive sequences in said candidate choices in a said session.
